(19) United States
(12) Patent Application Publication
(10) Pub. No.: US 2015/0324823 A1
(43) Pub. Date: Nov. 12, 2015

(54) METHOD AND SYSTEM FOR IDENTIFYING ASSOCIATED GEOLOCATIONS

(71) Applicant: MASTERCARD INTERNATIONAL INCORPORATED, Purchase, NY (US)

(72) Inventors: Kenny Unser, Fairfield, CT (US); Serge Bernard, Danbury, CT (US); Nikhil Malgatti, Stamford, CT (US)

(73) Assignee: MASTERCARD INTERNATIONAL INCORPORATED, Purchase, NY (US)

(21) Appl. No.: 14/270,634

(22) Filed: May 6, 2014

(51) Int. Cl. G06Q 30/02

(52) U.S. Cl. CPC G06Q 30/0205

(57) ABSTRACT

A method and a system are provided for identifying associated geolocations. The method involves retrieving from one or more databases a first set of information including payment card transaction information, and retrieving from one or more databases a second set of information including external information. The method further includes analyzing the first set of information and the second set of information to construct (i) one or more definitions of geography, (ii) one or more definitions of time, and (iii) one or more payment card holder lists by geography and by time period to identify payment card holder overlap, and creating one or more groupings of geographies and time periods based on the payment card holder overlap. The method and system provide advantages in fraud prevention, and can also be used by merchants or businesses to better target customers or enhance existing customer relationships.

### BACKGROUND OF THE DISCLOSURE

1. Field of the Disclosure

The present disclosure relates to a method and a system for identifying associated geolocations. In particular, the present disclosure relates to a method and a system for identifying associated geolocations based on payment card holder overlap. The method and system can be used by merchants or businesses to better target customers or enhance existing customer relationships. The method and system can also provide advantages in fraud prevention.

2. Description of the Related Art

Manufacturers, retailers, or other sellers of products (e.g. goods and services) services spend a lot of time and money trying to devise ways to get a consumer to buy their products. For example, companies advertise, send incentives for discounts, offer rewards, and other incentives to get consumers to initiate a transaction for the products. However, these efforts are typically provided to the public at large, or at least a relatively large group of consumers, which can result in a high cost and a low return. Also, the timing of any efforts is typically based on when the seller wants to send an incentive, with the seller having no insight as to a beneficial time or manner to send an incentive.

The availability of payment card transaction data provides unique opportunities to service a customer using a payment card. A possible benefit is that if the location of a payment card user is known, targeted advertising for that location can be sent to the user of the payment card. Thus, the user is informed of goods or services that are available at that location, and the issuer receives the possible benefit of one or more additional transactions being conducted by the payment card user.

A security concern with the use of payment cards is their use at locations other than the customary locations of use by a payment card user. Often, an issuer of a payment card (such as, for example, credit card, debit card, and prepaid card) has security concerns when questionable transactions at points of sale occur in places far from the residence of a payment card user.

Thus, a need exists for a system and a method that can identify, with as much certainty as possible, associations between locations and payment card users that may represent an opportunity for a merchant to offer products or services to the consumer that are specifically tailored to the consumer's upcoming need or desire and communicate the offers to the consumer. Further, a need exists for a system and a method that can identify, with as much certainty as possible, associations between locations and payment card users that can help to prevent or reduce the risk of fraud associated with payment card transactions.

### SUMMARY OF THE DISCLOSURE

The present disclosure provides a method and a system for identifying associated geolocations. In particular, the present disclosure relates to a method and a system for identifying associated geolocations based on payment card holder overlap. The method and system can be used by merchants or businesses to better target customers or enhance existing customer relationships. The method and system can also provide advantages in fraud prevention.

The present disclosure also provides a method that includes retrieving from one or more databases a first set of information comprising payment card transaction information, and retrieving from one or more databases a second set of information comprising external information. The method further involves analyzing the first set of information and the second set of information to construct (i) one or more definitions of geography, (ii) one or more definitions of time, and (iii) one or more payment card holder lists by geography and by time period to identify payment card holder overlap, and creating one or more groupings of geographies and time periods based on the payment card holder overlap. The method yet further includes creating one or more datasets to store information relating to the one or more groupings of geographies and time periods.

The present disclosure further provides developing logic for creating one or more groupings of geographies and time periods based on the payment card holder overlap. The present disclosure yet further provides applying the logic to a universe of geographies and time periods to create associations between the geographies and time periods.

The present disclosure also provides a system that includes one or more databases including a first set of information comprising payment card transaction information, and one or more databases including a second set of information comprising external information. The system includes a processor configured to: analyze the first set of information and the second set of information to construct (i) one or more definitions of geography, (ii) one or more definitions of time, and (iii) one or more payment card holder lists by geography and by time period to identify payment card holder overlap; and create one or more groupings of geographies and time periods based on the payment card holder overlap. The processor can be further configured to create one or more datasets to store information relating to the one or more groupings of geographies and time periods.

The present disclosure further provides a system in which the processor is configured with programmed logic to create one or more groupings of geographies and time periods based on the payment card holder overlap. The present disclosure yet further provides a system in which the processor is configured to apply the logic to a universe of geographies and time periods to create associations between the geographies and time periods.

The present disclosure still further provides a method for generating one or more predictive travel pattern profiles. The method comprises retrieving from one or more databases a first set of information comprising payment card transaction information, and retrieving from one or more databases a second set of information comprising external information. The method further includes analyzing the first set of information and the second set of information to construct (i) one or more definitions of geography, (ii) one or more definitions of time, and (iii) one or more payment card holder lists by geography and by time period to identify payment card holder overlap, and creating one or more groupings of geographies and time periods based on the payment card holder overlap. The method yet further includes comparing one or more payment card holders' travel patterns, based on historical payment card holder transaction data, with the one or more groupings of geographies and time periods, to identify one or more associations between the one or more payment card holders and the one or more groupings of geographies and time periods, and generating one or more predictive travel pattern profiles based on the one or more associations between the one or more payment card holders and the one or more groupings of geographies and time periods.

The present disclosure also provides a system that includes providing targeted information, based on the one or more predictive travel pattern profiles, to a payment card holder, and determining fraud risk based on the one or more predictive travel pattern profiles.

### BRIEF DESCRIPTION OF THE DRAWINGS

FIG. 1 is a diagram of a four party payment card system.

FIG. 2 illustrates a data warehouse shown in FIG. 1 that is a central repository of data which is created by storing certain transaction data from transactions occurring within four party payment card system of FIG. 1.

FIG. 3 is a block diagram of a portion of a payment card system used in accordance with the present disclosure.

FIG. 4 shows illustrative information types used in the systems and the methods of the present disclosure.

FIG. 5 illustrates an exemplary dataset for the storing, reviewing, and/or analyzing of information used in the systems and the methods of the present disclosure.

FIG. 6 is a flow chart illustrating a method of creating groupings of geographies and time periods based on payment card holder overlap, in accordance with exemplary embodiments of the present disclosure.

A component or a feature that is common to more than one drawing is indicated with the same reference number in each drawing.

### DESCRIPTION OF THE EMBODIMENTS

Embodiments of the present disclosure are described more fully hereinafter with reference to the accompanying drawings, in which some, but not all, embodiments of the present disclosure are shown. Indeed, the present disclosure can be embodied in many different forms and should not be construed as limited to the embodiments set forth herein. Rather, these embodiments are provided so that this disclosure clearly satisfies applicable legal requirements. Like numbers refer to like elements throughout.

As used herein, entities can include one or more persons, organizations, businesses, institutions and/or other entities, such as financial institutions, services providers, and the like that implement one or more portions of one or more of the embodiments described and/or contemplated herein. In particular, entities can include a person, business, school, club, fraternity or sorority, an organization having members in a particular trade or profession, sales representative for a particular product, charity, not-for-profit organization, labor union, local government, government agency, or political party. It should be understood that the methods and systems of this disclosure can be practiced by a single entity or by multiple entities. Although different entities can carry out different steps or portions of the methods and systems of this disclosure, all of the steps and portions included in the methods and systems of this disclosure can be carried out by a single entity.

As used herein, the one or more databases configured to store the first set of information or from which the first set of information is retrieved, and the one or more databases configured to store the second set of information or from which the second set of information is retrieved, can be the same or different databases.

The steps and/or actions of a method described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of storage medium known in the art. An exemplary storage medium can be coupled to the processor, such that the processor can read information from, and write information to, the storage medium. In the alternative, the storage medium can be integral to the processor. Further, in some embodiments, the processor and the storage medium can reside in an Application Specific Integrated Circuit (ASIC). In the alternative, the processor and the storage medium can reside as discrete components in a computing device. Additionally, in some embodiments, the events and/or actions of a method can reside as one or any combination or set of codes and/or instructions on a machine-readable medium and/or computer-readable medium, which can be incorporated into a computer program product.

In one or more embodiments, the functions described can be implemented in hardware, software, firmware, or any combination thereof. If implemented in software, the functions can be stored or transmitted as one or more instructions or code on a computer-readable medium. Computer-readable media includes both computer storage media and communication media including any medium that facilitates transfer of a computer program from one place to another. A storage medium can be any available media that can be accessed by a computer. By way of example, and not limitation, such computer-readable media can comprise RAM, ROM, EEPROM, CD-ROM or other optical disk storage, magnetic disk storage or other magnetic storage device, or any other medium that can be used to carry or store desired program code in the form of instructions or data structures, and that can be accessed by a computer. Also, any connection can be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc” as used herein, include compact disc (CD), laser disc, optical disc, digital versatile disc (DVD), floppy disk and blu-ray disc where disks usually reproduce data magnetically, while discs usually reproduce data optically with lasers. Combinations of the above are included within the scope of computer-readable media.

Computer program code for carrying out operations of embodiments of the present disclosure can be written in an object oriented, scripted or unscripted programming language such as Java, Perl, Smalltalk, C++, or the like. However, the computer program code for carrying out operations of embodiments of the present disclosure can also be written in conventional procedural programming languages, such as the “C” programming language or similar programming languages.

Embodiments of the present disclosure are described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions can also be stored in a computer-readable memory that can direct a computer or other programmable data processing apparatus to function in a particular manner, such that the instructions stored in the computer readable memory produce an article of manufacture including instruction means that implement the function/act specified in the flowchart and/or block diagram block(s).

The computer program instructions can also be loaded onto a computer or other programmable data processing apparatus to cause a series of operational steps to be performed on the computer or other programmable apparatus to produce a computer-implemented process so that the instructions that execute on the computer or other programmable apparatus provide steps for implementing the functions/acts specified in the flowchart and/or block diagram block(s). Alternatively, computer program implemented steps or acts can be combined with operator or human implemented steps or acts in order to carry out an embodiment of the present disclosure.

Thus, systems, methods and computer programs are herein disclosed to retrieve from one or more databases a first set of information comprising payment card transaction information, and retrieve from one or more databases a second set of information comprising external information. The first set of information and the second set of information are analyzed to construct (i) one or more definitions of geography, (ii) one or more definitions of time, and (iii) one or more payment card holder lists by geography and by time period to identify payment card holder overlap. One or more groupings of geographies and time periods are created based on the payment card holder overlap. One or more datasets are created to store information relating to the one or more groupings of geographies and time periods.

Among many potential uses, the systems and methods described herein can be used to: (1) allow merchants to better target customers and/or enhance existing customer relationships; and (2) prevent or reduce the risk of fraud associated with payment card transactions. Other uses are possible.

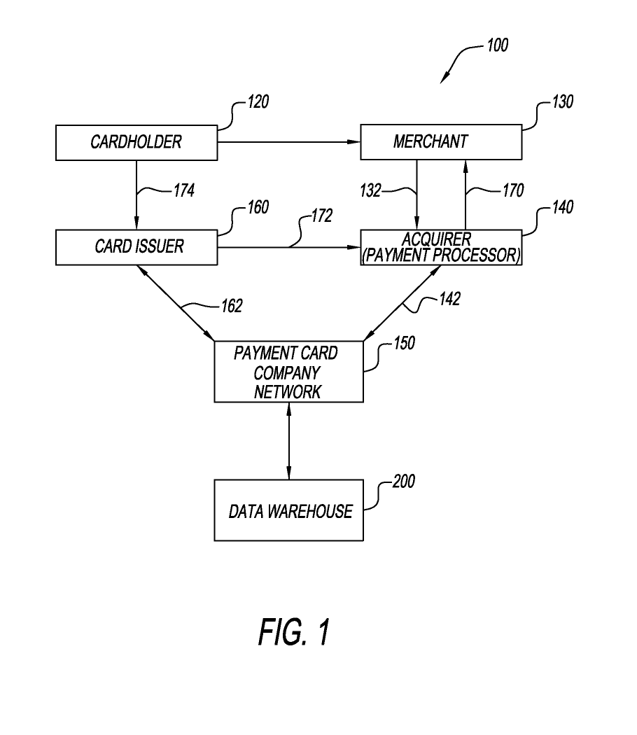

Referring to the drawings and, in particular, FIG. 1, there is shown a four party payment (credit, debit or other) card system generally represented by reference numeral 100. In card system 100, card holder 120 submits the payment card to the merchant 130. The merchant's point of sale (POS) device communicates 132 with his acquiring bank or acquirer 140, which acts as a payment processor. The acquirer 140 initiates, at 142, the transaction on the payment card company network 150. The payment card company network 150 (that includes a financial transaction processing company) routes, via 162, the transaction to the issuing bank or card issuer 160, which is identified using information in the transaction message. The card issuer 160 approves or denies an authorization request, and then routes, via the payment card company network 150, an authorization response back to the acquirer 140. The acquirer 140 sends approval to the POS device of the merchant 130. Thereafter, seconds later, if the transaction is approved, the card holder completes the purchase and receives a receipt.

The account of the merchant 130 is credited, via 170, by the acquirer 140. The card issuer 160 pays, via 172, the acquirer 140. Eventually, the card holder 120 pays, via 174, the card issuer 160.

Data warehouse 200 is a database used by payment card company network 150 for reporting and data analysis. According to one embodiment, data warehouse 200 is a central repository of data which is created by storing certain transaction data from transactions occurring within four party payment card system 100. According to another embodiment, data warehouse 200 stores, for example, the date, time, amount, location, merchant code, and merchant category for every transaction occurring within payment card network 150.

In yet another embodiment, data warehouse 200 stores, reviews, and/or analyzes information used in (i) constructing one or more definitions of geography, one or more definitions of time, and one or more payment card holder lists by geography and by time period to identify payment card holder overlap, (ii) creating one or more groupings of geographies and time periods based on the payment card holder overlap, (iii) creating one or more datasets to store information relating to the one or more groupings of geographies and time periods.

In still another embodiment, data warehouse 200 stores, reviews, and/or analyzes information used in creating one or more datasets to store information relating to the one or more groupings of geographies and time periods.

In another embodiment, data warehouse 200 stores, reviews, and/or analyzes information used in developing logic for creating one or more groupings of geographies and time periods based on the payment card holder overlap, and applying the logic to a universe of geographies and time periods to create associations between the geographies and time periods.

In yet another embodiment, data warehouse 200 stores, reviews, and/or analyzes information used in comparing one or more payment card holders' travel patterns, based on historical payment card holder transaction data, with the one or more groupings of geographies and time periods, to identify one or more associations between the one or more payment card holders and the one or more groupings of geographies and time periods.

In still another embodiment, data warehouse 200 stores, reviews, and/or analyzes information used in quantifying the strength of the one or more associations between the one or more payment card holders and the one or more groupings of geographies and time periods.

In another embodiment, data warehouse 200 stores, reviews, and/or analyzes information, with respect to the one or more associations between the one or more payment card holders and the one or more groupings of geographies and time periods, used in assigning attributes to the one or more payment card holders and the one or more groupings of geographies and time periods, wherein the attributes are selected from the group consisting of one or more of confidence, time, and frequency.

In yet another embodiment, data warehouse 200 stores, reviews, and/or analyzes information used in identifying one or more payment card holders, one or more groupings of geographies and time periods, and strength of the one or more associations between the one or more payment card holders and the one or more groupings of geographies and time periods.

In still another embodiment, data warehouse 200 stores, reviews, and/or analyzes information used in determining fraud risk based on the one or more associations between the one or more payment card holders and the one or more groupings of geographies and time periods, or targeting information including at least one or more suggestions or recommendations for payment card holder spending or purchasing activity at a geolocation, based on the one or more associations between the one or more payment card holders and the one or more groupings of geographies and time periods.

In another embodiment, data warehouse 200 aggregates the information by merchant and/or category and/or location. In still another embodiment, data warehouse 200 integrates data from one or more disparate sources. Data warehouse 200 stores current as well as historical data and is used for creating reports, performing analyses on the network, merchant analyses, and performing predictive analyses.

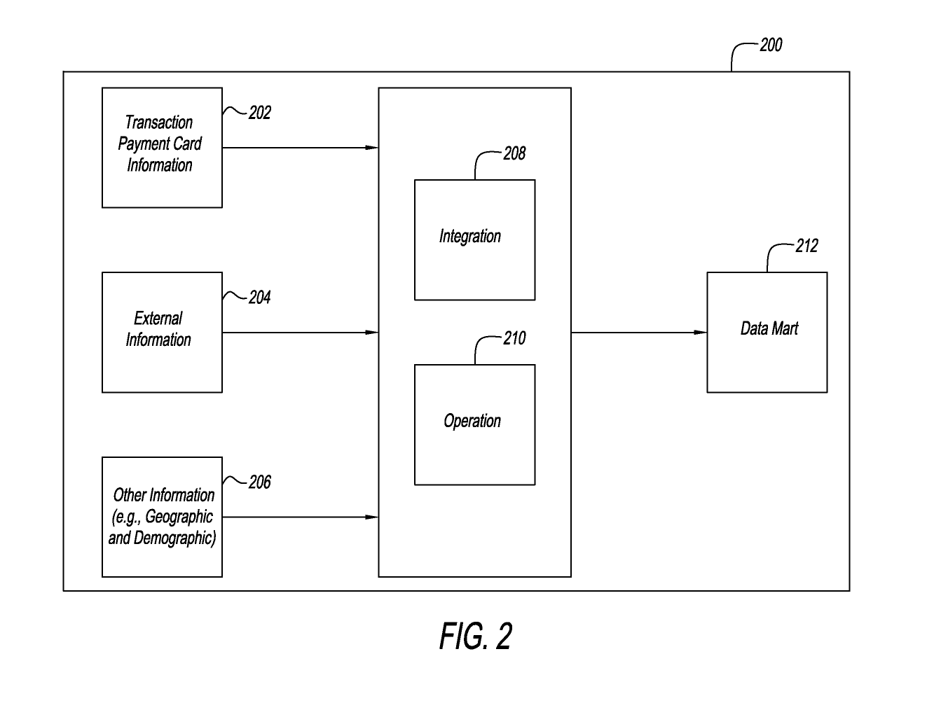

FIG. 2 illustrates an exemplary data warehouse 200 (the same data warehouse 200 in FIG. 1) for reporting and data analysis, including the storing, reviewing, and/or analyzing of information, for the various purposes described above. The data warehouse 200 can contain a plurality of entries (e.g., entries 202, 204, and 206).

The payment card transaction information 202 can contain, for example, purchasing and payment activities attributable to purchasers (e.g., payment card holders), that is aggregated by merchant and/or category and/or location in the data warehouse 200. The external information 204 includes, for example, geographic areas, calendar data, and weather data. Other information 206 can include demographic or geographic or other suitable information that may be useful in constructing one or more definitions of geography, one or more definitions of time, and one or more payment card holder lists by geography and by time period to identify payment card holder overlap, and creating one or more groupings of geographies and time periods based on the payment card holder overlap.

The typical data warehouse uses staging, data integration, and access layers to house its key functions. The staging layer or staging database stores raw data extracted from each of the disparate source data systems. The integration layer integrates at 208 the disparate data sets by transforming the data from the staging layer often storing this transformed data in an operational data store database 210. For example, the payment card transaction information 202 can be aggregated by merchant and/or category and/or location at 208. Also, the reporting and data analysis, including the storing, reviewing, and/or analyzing of information, for the various purposes described above, can occur in data warehouse 200. The integrated data is then moved to yet another database, often called the data warehouse database or data mart 212, where the data is arranged into hierarchical groups often called dimensions and into facts and aggregate facts. The access layer helps users retrieve data.

A data warehouse constructed from an integrated data source systems does not require staging databases or operational data store databases. The integrated data source systems may be considered to be a part of a distributed operational data store layer. Data federation methods or data virtualization methods may be used to access the distributed integrated source data systems to consolidate and aggregate data directly into the data warehouse database tables. The integrated source data systems and the data warehouse are all integrated since there is no transformation of dimensional or reference data. This integrated data warehouse architecture supports the drill down from the aggregate data of the data warehouse to the transactional data of the integrated source data systems.

The data mart 212 is a small data warehouse focused on a specific area of interest. For example, the data mart 212 can be focused on one or more of reporting and data analysis, including the storing, reviewing, and/or analyzing of information, for any of the various purposes described above. Data warehouses can be subdivided into data marts for improved performance and ease of use within that area. Alternatively, an organization can create one or more data marts as first steps towards a larger and more complex enterprise data warehouse.

This definition of the data warehouse focuses on data storage. The main source of the data is cleaned, transformed, cataloged and made available for use by managers and other business professionals for data mining, online analytical processing, market research and decision support. However, the means to retrieve and analyze data, to extract, transform and load data, and to manage the data dictionary are also considered essential components of a data warehousing system. Many references to data warehousing use this broader context. Thus, an expanded definition for data warehousing includes business intelligence tools, tools to extract, transform and load data into the repository, and tools to manage and retrieve metadata.

Algorithms can be employed to determine formulaic descriptions of the integration of the data source information using any of a variety of known mathematical techniques. These formulas in turn can be used to derive or generate one or more analyses and updates for analyzing, creating, comparing and identifying activities using any of a variety of available trend analysis algorithms. For example, these formulas can be used in the reporting and data analysis, including the storing, reviewing, and/or analyzing of information, for the various purposes described above.

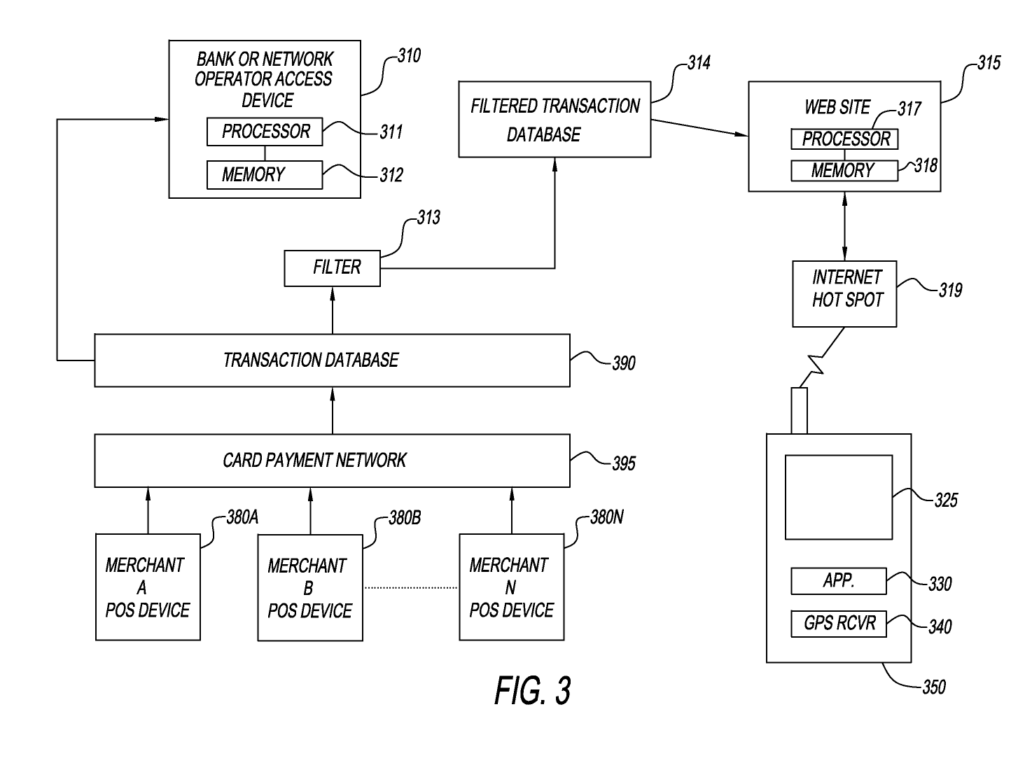

Referring to the drawings and, in particular, FIG. 3, a portion of a payment card system used in accordance with the present disclosure is shown. Each merchant that accepts a payment card has on their premises at least one card swiping machine or point of sale device 380, of a type well known in the art, for initiating customer transactions. These point of sale devices 380A, 380B, . . . 380N, generally have a keyboard data pad for entering data when a card's magnetic coding becomes difficult to read, or for the purpose of entering card data resulting from telephone calls during which the customer provides card data by telephone.

Point of sale devices 380A, 380B, . . . 380N are connected by a suitable card payment network 385 (the payment card company network 150 in FIG. 1) to a transaction database 390 associated with or within network 395 that stores information concerning the transactions. The transaction database is included in the data warehouse 200 in FIGS. 1 and 2. An example of such a network 395 is BankNet operated by MasterCard International Incorporated. BankNet is a four party payment network that connects a card issuer, a card holder, merchants, and an acquiring bank, as is well known in the art. In another embodiment, network 395 can be a three party system. In any such embodiment, POS devices 380 do not have direct access to transaction database 390. It is the operator of network 395 that can access transaction database 390.

Information in database 390 can be accessed by a bank or network operator access device 310, such as a computer having a processor 311 and a memory 312. Users of device 310 can be employees of the bank or a payment network operator who are doing research or development work, such as running inquiries, to carry out the reporting and data analysis, including the storing, reviewing, and/or analyzing of information, for the various purposes described above.

Transaction records stored in transaction database 390 contain information that is highly confidential and must be maintained confidential to prevent fraud and identity theft. The transaction records stored in transaction database 390 can be anonymized by using a filter 313 that removes confidential information, but retains records concerning all of the other transaction related details discussed above, preferably in real time. Anonymized data is generally necessary for marketing applications. The filtered data is stored in a filtered transaction database 314 that can be accessed as described below. The data in the filtered transaction database 314 can be stored in any type of memory including a hard drive, a flash memory, on a CD, in a RAM, or any other suitable memory.

The following example of an approach to accessing the data involves a mobile telephone. However, it is understood that that there are various other approaches, technologies and pathways that can be used, including direct access by employees of the card issuing bank or a payment network operator.

A mobile telephone 350 having a display 325 can have a series of applications or applets thereon including an applet or application program (hereinafter an application) 330 for use with the embodiment described herein. Mobile telephone 350 can also be equipped with a GPS receiver 340 so that its position is always known.

Mobile telephone 350 can be used to access a website 315 on the Internet, via an Internet connected Wi-Fi hot spot 319 (or by any telephone network, such as a 3G or 4G system, on which mobile telephone 350 communicates), by using application 330. Website 315 is linked to database 314 so that authorized users of website 315 can have access to the data contained therein. These users can be employees of the bank or a network operator who is making inquiries as described above with bank or operator access device 310.

Web site 315 has a processor 317 for assembling data from filtered transaction database 314 for responding to inquiries. A memory 318 associated with web site 315 having a non-transitory computer readable medium, stores computer readable instructions for use by processor 317 in implementing the operation of the disclosed embodiment.

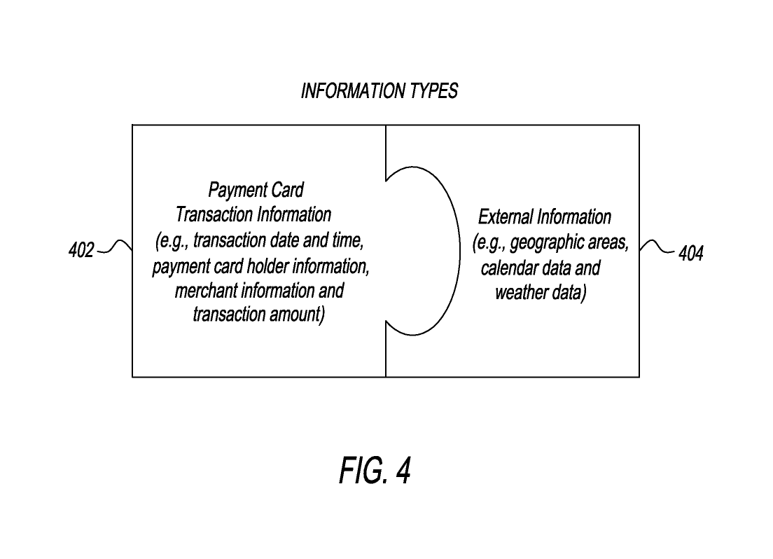

In accordance with the method of this disclosure, information that is stored in one or more databases can be retrieved (e.g., by a processor). FIG. 4 shows illustrative information types used in the systems and methods of this disclosure.

The information can contain, for example, a first set of information including payment card transaction information 402. Illustrative first set of information can include, for example, transaction date and time, payment card holder information, merchant information and transaction amount. In particular, the payment card transaction information can include, for example, transaction date/time, payment card holder information (e.g., payment card holder account identifier (likely anonymized), payment card holder geography (potentially modeled), payment card holder type (consumer/business), payment card holder demographics, and the like), merchant information (e.g., merchant name, merchant geography, merchant line of business, and the like), and payment transaction amount information. Information for inclusion in the first set of information can be obtained, for example, from payment card companies known as MasterCard®, Visa®, American Express®, and the like (part of the payment card company network 150 in FIG. 1).

Also, the information can contain, for example, a second set of information including external information 404. Illustrative second set information can include, for example, geographic areas, calendar data, weather data, and the like. In particular, the second set of information can include, for example, geographic areas (e.g., metropolitan areas (metropolitan statistical area (MSA), designated market area (DMA), and the like), event venues, and the like), calendar information (e.g., open seasons such as beach seasons, ski seasons, and the like, retail calendar, seasonal/holiday information such as observances of shifting holidays such as Easter), weather (e.g., snowfall, rain, temperature, and the like), and the like. The second set of information can be categorized, for example, by country, state, zip code, and the like. The geolocations can be clustered (i.e., location clusters) by category, for example, by activities, events, or other categories.

In an embodiment, all information stored in each of the one or more databases can be retrieved. In another embodiment, only a single entry in each database can be retrieved. The retrieval of information can be performed a single time, or can be performed multiple times. In an exemplary embodiment, only information pertaining to a specific predictive travel pattern profile is retrieved from each of the databases.

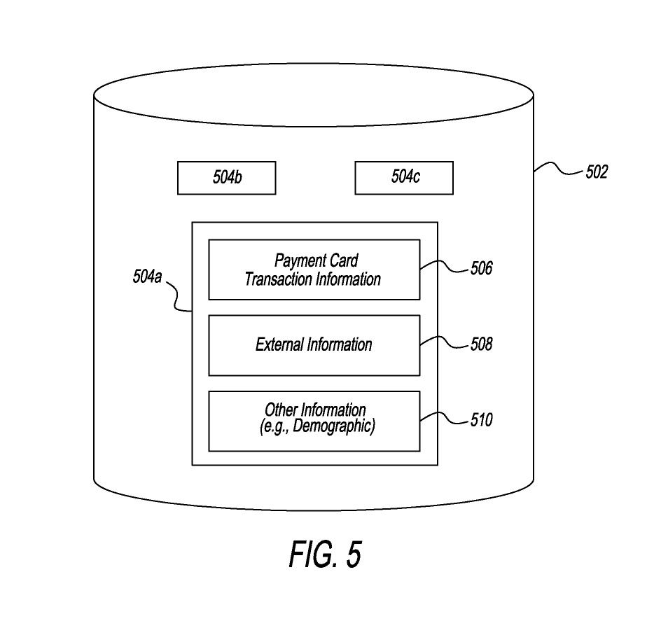

FIG. 5 illustrates an exemplary dataset 502 for the storing, reviewing, and/or analyzing of information used in the systems and methods of this disclosure. The dataset 502 can contain a plurality of entries (e.g., entries 504a, 504b, and 504c).

The payment card holder transaction information 506 includes payment card transactions and actual spending. The payment card transaction information 506 can contain, for example, transaction date/time, payment card holder information (e.g., payment card holder account identifier (likely anonymized), payment card holder geography (potentially modeled), payment card holder type (consumer/business), payment card holder demographics, and the like), merchant information (e.g., merchant name, merchant geography, merchant line of business, and the like), payment transaction amount information, and the like. The external information 508 includes, for example, geographic areas, calendar data, weather data, and the like. Other information 510 can include demographic or other suitable information that can be useful in conducting the systems and methods of this disclosure.

Algorithms can be employed to determine formulaic descriptions of the integration of the payment card transaction information and the external information using any of a variety of known mathematical techniques. These formulas, in turn, can be used to derive or generate one or more analyses and updates for a geolocation grouping or clustering activity using any of a variety of available trend analysis algorithms. For example, these formulas can be used to analyze the payment card transaction data and the external information to construct (i) one or more definitions of geography, (ii) one or more definitions of time, and (iii) one or more payment card holder lists by geography and by time period to identify payment card holder overlap, and to create one or more groupings of geographies and time periods based on the payment card holder overlap.

In an embodiment, logic is developed for creating one or more groupings of geographies and time periods based on the payment card holder overlap. The logic is applied to a universe of geographies and time periods to create associations between the geographies and time periods.

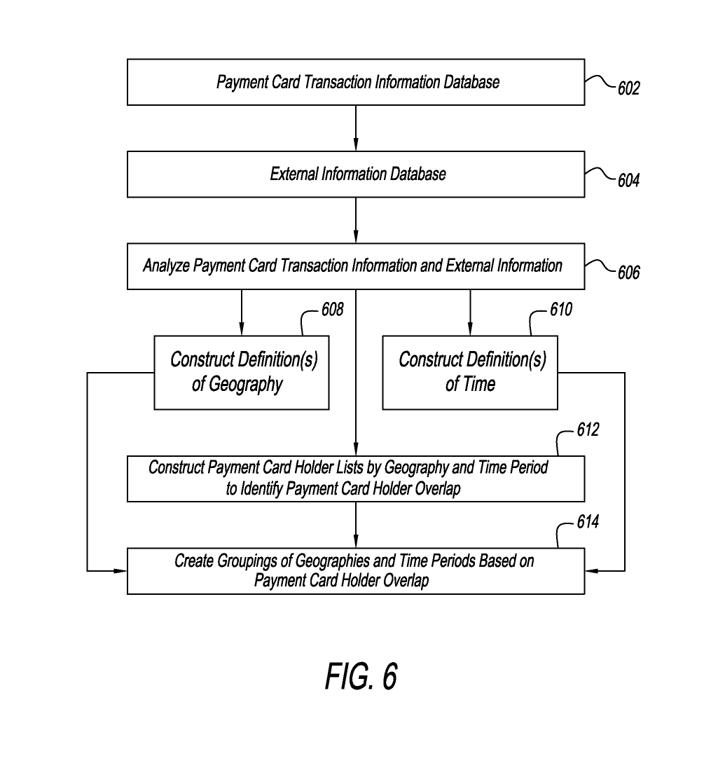

Referring to FIG. 6, the methods and the systems of this disclosure involve retrieving at 602 from one or more databases a first set of information comprising payment card transaction information, and retrieving at 604 from one or more databases a second set of information comprising external information. The method further includes analyzing at 606 the first set of information and the second set of information to construct (i) one or more definitions of geography at 608, (ii) one or more definitions of time at 610, and (iii) one or more payment card holder lists by geography and by time period to identify payment card holder overlap at 612, and creating at 614 one or more groupings of geographies and time periods based on the payment card holder overlap.

In particular, the methods and the systems of this disclosure include a segment for data analysis and a segment for applying insights. In the data analysis segment, a data layout universe is constructed including, but not limited to, payment card transaction data and external data. The payment card transaction data can include, for example, transaction date/time, payment card holder information (e.g., payment card holder account identifier (likely anonymized), payment card holder geography (potentially modeled), payment card holder type (consumer/business), payment card holder demographics, and the like), merchant information (e.g., merchant name, merchant geography, merchant line of business, and the like), and payment transaction amount information.

The external data can include, for example, geographic areas (e.g., metropolitan areas, event venues, and the like), calendar information (e.g., open seasons such as beach seasons, ski seasons, and the like, retail calendar, seasonal/holiday information such as observances of shifting holidays such as Easter), and weather (e.g., snowfall, rain, temperature, and the like).

Filters can be used for selecting certain data within the data layout universe. For example, a time range filter can be used that can vary based on need or data availability.

The data within the data layout universe is then analyzed to construct logical definitions of geography, logical definitions of time, and payment card holder lists by geography and by time period, and to create logical groupings of geographies/time periods based on payment card holder overlap.

The construct of logical definitions of geography involves, for example, building common sense business definitions, incorporation of external data into construct definitions, and using standard statistical analysis techniques (e.g., clustering, regression, correlation, segmentation, raking, and the like). Logic and/or algorithms can be used to construct the logical definitions of geography.

The construct of logical definitions of time involves, for example, building common sense business definitions, incorporation of external data into construct definitions, and using standard statistical analysis techniques (e.g., clustering, regression, correlation, segmentation, raking, and the like). Logic and/or algorithms can be used to construct the logical definitions of time.

The construct of payment card holder lists by geography and by time period involves, for example, using merchant data to assign geography, using authorization data to assign date/time, and overlaying geography and time definitions.

The creation of logical groupings of geographies/time periods based on payment card holder overlap involves, for example, using standard statistical analysis techniques (e.g., clustering, regression, correlation, segmentation, raking, and the like), and quantifying the strength of the association. Logic and/or algorithms can be used to create the logical groupings of geographies/time periods based on payment card holder overlap.

A data set can be created to store the data that includes, for example, geographic grouping identification, geography, time period(s), strength of the association to grouping, and the like.

In the applying insights segment, based on historical payment card transaction data, a payment card holder's travel pattern can be compared to the various geographic groupings defined in the analysis segment. The strength of the association between a payment card holder and a geographic grouping can be quantified. The output from the applying insights segment can include, for example, payment card holder identification, geographic grouping identification, strength of the association, and the like.

For example, without knowing why they are connected, the method and system of this disclosure can create a list of ski towns (e.g., Vail, Breckenridge, Park City, Killington, and the like) and recognize that the association is linked to winter.

In another example, without knowing why they are connected, the method and system of this disclosure can identify the sites of horse shows and the sequence and/or specific dates of the events.

For example, Louisville, Ky., Baltimore, Md. and Belmont, N.Y. may be seemingly unrelated locations, but they are the three locations of the horse racing “Triple Crown”. Similarly, Summersville, W. Va., Saluda, N.C. and Banks, Idaho are all kayaking towns. Ski towns, biker rally towns, technology convention towns, comic convention towns, and the like are other examples of locations that can be related based on a particular sub-population of payment card holders.

In an embodiment of this disclosure, a payment card holder is observed to make purchases in several ski towns in winter months. A ski resort can target the customer with an offer for a reduced price lift ticket.

In another embodiment of this disclosure, a payment card holder is observed to make purchases in several geographies during horse shows. If the payment card holder uses his or her card in a new city during a horse show, the transaction should not be suspected of being fraudulent.

The one or more predictive travel pattern profiles are generated based on the associated geolocations. The predictive travel pattern profiles are discussed more fully hereinbelow.

Associations between payment card holders and the groupings of geographies can be assessed based on the one or more predictive travel pattern profiles. For example, in a fraud assessment situation, a payment card holder is observed to make purchases in several ski towns in winter months and shows up for the first time in Park City, Utah. Based on the predictive travel pattern profile of the payment card holder, any payment card transaction activity in Park City, Utah would be consistent with the previous spending behavior, despite the fact that the payment card holder had never before been to Park City, Utah. As another example, in a targeted advertisement situation, a payment card holder went on three biker rallies on the East Coast last year. Based on the predictive travel pattern profile of the payment card holder, the payment card holder would likely be interested in offers related to biker rallies in South Dakota.

The above examples illustrate how the systems and the methods of this disclosure can be used to make associations between payment card holders and groupings of geographies based on the one or more predictive travel pattern profiles. In particular, the systems and the methods of this disclosure can be used by merchants or businesses to better target customers or to enhance existing customer relationships, and also be used to prevent or reduce the risk of fraud in payment card transactions.

As indicated herein, the systems and the methods of this disclosure utilize standard statistical techniques (e.g., clustering, regression, correlation, segmentation, raking, and the like) to identify sets of geographies that seem to have a relationship based on the payment card transaction activity of overlapping payment card holders. The relationships can be refined by looking at factors such as time, logical geographic breaks, frequency, and the like.

Logic can be created for associating the geolocations and then quantifying their relationship (e.g., confidence quantifier). Once the logic has been created, it can be applied to the universe of geographies to create associations between geographies (i.e., geographic clusters). Attributes (e.g., confidence, time, frequency, and the like) can then be assigned to the clusters and/or members of the clusters to make the data useful to potential end users such as marketers and fraud investigators.

In accordance with the methods of this disclosure, one or more predictive travel pattern profiles are generated based on associations identified between a payment card holder and the groupings of geographies. Predictive travel pattern profiles can be selected based on the information obtained and stored in the one or more databases. The selection of information for representation in the predictive travel pattern profiles can be different in every instance. In one embodiment, all information stored in each database can be used for selecting predictive travel pattern profiles. In an alternative embodiment, only a portion of the information is used. The generation and selection of predictive travel pattern profiles may be based on specific criteria.

A method for generating one or more predictive travel pattern profiles is an embodiment of this disclosure. The method involves creating one or more groupings of geographies and time periods based on the payment card holder overlap in accordance with this disclosure, and then comparing one or more payment card holders' travel patterns, based on historical payment card holder transaction data, with the one or more groupings of geographies and time periods, to identify one or more associations between the one or more payment card holders and the one or more groupings of geographies and time periods. One or more predictive travel pattern profiles are generated based on the one or more associations between the one or more payment card holders and the one or more groupings of geographies and time periods.

A geolocation confidence score can be used for conveying to the one or more entities the travel pattern attributable to the one or more payment card holders based on the one or more predictive travel pattern profiles. The geolocation confidence score is indicative of likelihood to travel to a certain geolocation.

It will be understood that the present disclosure can be embodied in a computer readable non-transitory storage medium storing instructions of a computer program that when executed by a computer system results in performance of steps of the method described herein. Such storage media can include any of those mentioned in the description above.

Where methods described above indicate certain events occurring in certain orders, the ordering of certain events can be modified. Moreover, while a process depicted as a flowchart, block diagram, and the like can describe the operations of the system in a sequential manner, it should be understood that many of the system's operations can occur concurrently or in a different order.

The terms “comprises” or “comprising” are to be interpreted as specifying the presence of the stated features, integers, steps or components, but not precluding the presence of one or more other features, integers, steps or components or groups thereof.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it can be based on one or more other things as well. In other words, unless expressly indicated otherwise, as used herein “based on” means “based at least in part on” or “based at least partially on.”

The techniques described herein are exemplary, and should not be construed as implying any particular limitation on the present disclosure. It should be understood that various alternatives, combinations and modifications could be devised by those skilled in the art from the present disclosure. For example, steps associated with the processes described herein can be performed in any order, unless otherwise specified or dictated by the steps themselves. The present disclosure is intended to embrace all such alternatives, modifications and variances that fall within the scope of the appended claims.

What is claimed is:

1. A method comprising:
retrieving from one or more databases a first set of information comprising payment card transaction information;
retrieving from one or more databases a second set of information comprising external information;
analyzing the first set of information and the second set of information to construct (i) one or more definitions of geography, (ii) one or more definitions of time, and (iii) one or more payment card holder lists by geography and by time period to identify payment card holder overlap; and
creating one or more groupings of geographies and time periods based on the payment card holder overlap.

2. The method of claim 1, further comprising creating one or more datasets to store information relating to the one or more groupings of geographies and time periods.

3. The method of claim 1, further comprising developing logic for creating one or more groupings of geographies and time periods based on the payment card holder overlap, and applying the logic to a universe of geographies and time periods to create associations between the geographies and time periods.

4. The method of claim 1, further comprising comparing one or more payment card holders' travel patterns, based on historical payment card holder transaction data, with the one or more groupings of geographies and time periods, to identify one or more associations between the one or more payment card holders and the one or more groupings of geographies and time periods.

5. The method of claim 4, further comprising quantifying the strength of the one or more associations between the one or more payment card holders and the one or more groupings of geographies and time periods.

6. The method of claim 4, further comprising, with respect to the one or more associations between the one or more payment card holders and the one or more groupings of geographies and time periods, assigning attributes to the one or more payment card holders and the one or more groupings of geographies and time periods, wherein the attributes are selected from the group consisting of one or more of confidence, time, and frequency.

7. The method of claim 4, further comprising identifying one or more payment card holders, one or more groupings of geographies and time periods, and strength of the one or more associations between the one or more payment card holders and the one or more groupings of geographies and time periods.

8. The method of claim 4, further comprising determining fraud risk based on the one or more associations between the one or more payment card holders and the one or more groupings of geographies and time periods, or targeting information including at least one or more suggestions or recommendations for payment card holder spending or purchasing activity at a geolocation, based on the one or more associations between the one or more payment card holders and the one or more groupings of geographies and time periods.

9. The method of claim 1, wherein the payment card transaction information comprises transaction date and time, payment card holder information, merchant information and transaction amount, and external information that comprises geographic areas, calendar data, and weather data.

10. The method of claim 1, wherein the one or more definitions of geography, the one or more definitions of time, and the one or more groupings of geographies and time periods are constructed by statistical analysis selected from the group consisting of clustering, regression, correlation, segmentation, and raking.

11. The method of claim 1, further comprising quantifying the strength of the one or more groupings of geographies and time periods.

12. The method of claim 1, further comprising algorithmically constructing the one or more definitions of geography, algorithmically constructing the one or more definitions of time, and/or algorithmically creating the one or more groupings of geographies and time periods.

13. A system comprising:
one or more databases including a first set of information comprising payment card transaction information;
one or more databases including a second set of information comprising external information;
a processor configured to:
analyze the first set of information and the second set of information to construct (i) one or more definitions of geography, (ii) one or more definitions of time, and (iii) one or more payment card holder lists by geography and by time period to identify payment card holder overlap; and
create one or more groupings of geographies and time periods based on the payment card holder overlap.

14. The system of claim 13, wherein the processor is configured to create one or more datasets to store information relating to the one or more groupings of geographies and time periods.

15. The system of claim 13, wherein the processor is configured with a programmed logic to create one or more groupings of geographies and time periods based on the payment card holder overlap, and to apply the logic to a universe of geographies and time periods to create associations between the geographies and time periods.

16. The system of claim 13, wherein the processor is configured to compare one or more payment card holders' travel patterns, based on historical payment card holder transaction data, with the one or more groupings of geographies and time periods, to identify one or more associations between the one or more payment card holders and the one or more groupings of geographies and time periods.

17. The system of claim 16, wherein the processor is configured, with respect to the one or more associations between the one or more payment card holders and the one or more groupings of geographies and time periods, to assign attributes to the one or more payment card holders and the one or more groupings of geographies and time periods, and wherein the attributes are selected from one or more of confidence, time, and frequency.

18. The system of claim 16, wherein the processor is further configured to identify one or more payment card holders, one or more groupings of geographies and time periods, and strength of the one or more associations between the one or more payment card holders and the one or more groupings of geographies and time periods.

19. The system of claim 16, wherein the processor is further configured to determine fraud risk based on the one or more associations between the one or more payment card holders and the one or more groupings of geographies and time periods, or to target information including at least one or more suggestions or recommendations for payment card holder spending or purchasing activity at a geolocation, based on the one or more associations between the payment card holders and the one or more groupings of geographies and time periods.

20. The system of claim 13, wherein the one or more definitions of geography, the one or more definitions of time, and the one or more groupings of geographies and time periods are constructed by statistical analysis selected from the group consisting of clustering, regression, correlation segmentation and raking.

21. The system of claim 13, wherein the processor is further configured to quantify the strength of the one or more groupings of geographies and time periods.

22. The system of claim 13, wherein the processor is configured to algorithmically construct the one or more definitions of geography, algorithmically construct the one or more definitions of time, and algorithmically create the one or more groupings of geographies and time periods.

23. A method for generating one or more predictive travel pattern profiles, said method comprising:
retrieving from one or more databases a first set of information comprising payment card transaction information;
retrieving from one or more databases a second set of information comprising external information;
analyzing the first set of information and the second set of information to construct (i) one or more definitions of geography, (ii) one or more definitions of time, and (iii) one or more payment card holder lists by geography and by time period to identify payment card holder overlap;
creating one or more groupings of geographies and time periods based on the payment card holder overlap;
comparing one or more payment card holders' travel patterns, based on historical payment card holder transaction data, with the one or more groupings of geographies and time periods, to identify one or more associations between the one or more payment card holders and the one or more groupings of geographies and time periods; and
generating one or more predictive travel pattern profiles based on the one or more associations between the one or more payment card holders and the one or more groupings of geographies and time periods.
